(19) United States
(12) Patent Application Publication
(10) Pub. No.: US 2026/0134031 A1
(43) Pub. Date: May 14, 2026

(54) A COMPUTER ASSISTED METHOD FOR CLASSIFYING DIGITAL AUDIO FILES

(71) Applicant: Wetweak SA, Neuchâtel (CH)

(72) Inventors: David André Ramos Santos, Peseux (CH); Filipe Ramos Santos, Neuchâtel (CH)

(73) Assignee: Wetweak SA, Neuchâtel (CH)

(21) Appl. No.: 19/120,021

(22) PCT Filed: Oct. 10, 2023
(86) PCT No.: PCT/IB2023/060168

§ 371 Date: Apr. 10, 2025

(30) Foreign Application Priority Data
Oct. 10, 2022 (CH) CH001192/2022

(51) Int. Cl. G06F 16/65; G06F 16/683

(52) U.S. Cl. CPC G06F 16/65; G06F 16/683

(57) ABSTRACT

A computer assisted method for classifying digital audio files based on features of a digital audio signal comprised in the file, comprising: storing the audio file in a digital memory; determining a portion (p) of drop of the audio file, for example the portion with the highest subjective loudness; classifying said audio file based on features of said drop.

### TECHNICAL DOMAIN

The present invention concerns a method for classifying digital audio files, such as music files, based on low-level features of the audio signal stored in the file.

### RELATED ART

The amount of music being created is increasing every year, as is the number of music tracks stored and available to consumers. Streaming platforms such as Spotify®, Tidal® and Deezer®, for example, host tens of millions of songs available to subscribers for download.

An efficient mechanism for selecting tracks from such large catalogs is essential for users to discover new songs and quality artists. A manual selection becomes impossible when the number of audio files becomes large. For example, it would take more than 300 years to listen to all the content of Spotify®. Therefore, automated selection and ranking tools are crucial for assisting users to find the desired content.

Currently, most such music use rankings based on the popularity of tracks and artists, e.g. the number of listens, and user engagement, e.g. the number of times a track is played to completion, repeated, or saved to a playlist. These popularity-based algorithms, however, do not allow for easy discovery of new tracks or artists before they become popular, and instead reinforce the popularity of already well known and often listened artists.

Furthermore, a same track by a same artist may be uploaded several times to the same music platform, but with different recording qualities. It is difficult for the platform to automatically choose the best recording, so the user searching for that track is often forced to listen to several recordings before choosing the best one. This results in an uncomfortable user experience, and bandwidth wasted on unnecessarily playing bad recordings of one song.

Thus, there is a need for a process to automatically sort audio files proposed to users, and/or to automatically offer the best version of a recording.

There is also a need for the operators of such platforms, for the musicians, and for the producers, to predict in advance if a specific song or piece of music will be successful, so as to avoid distributing or promoting audio files which are less likely to be successful. Currently, this evaluation of the quality of music songs is mainly a human process, and therefore both time-consuming and subjective. There is a need in the prior art for an automated process of predicting the success of an audio track.

One factor in the explosion of available music content is the increasing ease with which music, especially electronic music, can be created using sound design software, or DAWs (Digital Audio Workstations). Creating electronic music most often involves selecting samples from sample packs or using a synthesizer, arranging the selected or generated samples musically, applying presets and often combining them with recordings of vocals or non-electronic instruments. There are therefore large collections of audio samples available to musicians who create electronic music. The selection of the best samples from these collections is, again, a very tedious and subjective process.

Moreover, these numerous steps in the process of creating an electronic music piece involve an iterative approach, with a verification of the result of each modification and listening to the intermediate audio files after each iteration. This process is therefore slow, and again subjective.

Music tracks and samples are often assigned to a music genre. This genre is often selected by the musician or producer who uploads the corresponding music file to a music platform. The number of music genres is very high, and the classification in one genre or the other sometimes subjective, so that many audio files are not classified into the most appropriate music genre, making it difficult for users to retrieve misclassified audio files. In addition, new genres are routinely defined, so that previously classified audio files need to be reclassified.

Thus, there is a need in the state of the art for a computer assisted process to classify music tracks, samples, or other audio files automatically, with less subjectivity, and using low-level parameters.

Methods based on artificial intelligence have been suggested in the prior art for predicting the success of a music song. However, using all the samples of an audio file as input for a neural network requires a very large and expensive neural network. Such a network is slow and difficult to train. There is a need for a method of classifying audio files that does not require such a large and slow neural network.

### SHORT DISCLOSURE OF THE INVENTION

According to the invention, these aims are attained by the object of the attached claims, and especially by a computer assisted method for classifying digital audio files based on features of a digital audio signal (tₖ) comprised in the file, comprising:
storing the audio file in a digital memory;
determining a portion (p) of the audio file included in the drop of the audio file;
   classifying said audio file based on features of said portion (p).

The portion (p) may be the loudest portion (p) of the audio file, for example the portion with the highest subjective loudness.

The expression “loudest portion” may be subjective, and designate the portion considered to be the loudest, or a portion likely to be considered the loudest portion, of an audio file.

In one embodiment, these aims are attained by the object of the attached claims, and especially by a computer assisted method for classifying digital audio files based on features of a digital audio signal comprised in the file, comprising:
storing the audio file in a digital memory;
determining the so called loudest portion of the audio file, for example the portion of the audio file with the highest subjective loudness;
computing a digital frequency transform of said portion;
dividing said digital frequency transform into a plurality of predefined frequency ranges;
determining the subjective loudness in each said frequency ranges;
classifying said audio file based on the subjective loudness in each said frequency range.

The audio file may be a music track, such as a music piece, a portion of such a music track, a sample, or any other audio file representing music.

The subjective loudness may be measured in LUFS (loudness units relative to full scale) or any other unit that indicate the subjective, i.e., perceived loudness of a monochannel or multichannel signal.

The digital memory may be a local memory in a device of the user, or a remote memory, for example in a cloud.

The computer assisted method may be executed by a computer, a server, a network of computing resources in the cloud, a smartphone, a tablet etc.

The classifying of audio files is thus based on a loudness in predefined frequency ranges, i.e., on a reduced number of low-level features of the audio signal. It can thus be performed with a relatively small classifying engine, and thus much faster than methods where each sample of the music is entered into one classifying engine, or if more features of the audio signal were used.

Tests have shown that this classification of audio files based on subjective loudness in predefined frequency ranges provides a reliable correlation with the popularity or success of the audio track, and/or for classifying the audio file according to a music genre for example. It this provides an automatic, fast and objective way of classifying audio files, which can be used for ranking or selecting them.

According to one aspect, the invention thus permits an automated classification of audio files or collection of audio files, based on low level parameters of an important portion of the audio signal, and thus with less subjectivity and much faster than human-made classification methods.

According to one aspect, the invention relies on the realization that the classification such as the perceived quality of an audio file, in particular a musical signal, is determined primarily by a portion of the signal that is loud, for example by the drop, or a portion of the drop.

The portion (p) used for classification of the audio file may be a portion which has the highest subjective loudness (expressed for example in LUFS). Focusing on a loud portion, such as the drop or a portion of the drop, instead of the whole audio file, makes the classification process more reliable, more efficient and faster, circumventing an analysis of other portions of the signal that are less important for their classification.

The loudest portion of the audio file often corresponds to the drop of the song in electronic music, or to a portion of the drop.

According to another aspect, the invention is also based on the realization that the classification such as the perceived quality and/or music genre of an audio file, such as a music piece, can be determined, at least in part, from the subjective loudness within different predefined ranges of that loud portion. Determining the subjective loudness within each of these frequency ranges thus provides a reliable and automatable means of classifying musical audio files.

The method may comprise a step of computing proportions of subjective loudness values between a plurality of said frequency ranges.

The subjective loudness in each such frequency range may be compared with reference subjective loudness values. The classifying may be based on the comparison.

The method may comprise a step of computing difference between subjective loudness values in a plurality of said frequency ranges and reference subjective loudness values for a specific music genre.

For example, a proportion between the subjective loudness in different frequency ranges different from the proportion between reference subjective loudness values in those frequency ranges might indicate a poorly mixed track, a bad track, or a track that does not correspond to the expected music genre.

The comparison might be analytic, for example by comparing ratios between subjective loudness values in different frequency ranges, or by comparing ratios between measured subjective loudness values of each frequency range with reference subjective loudness values for those frequency ranges.

The classification might be performed with a machine learning based classifying engine, such as a neural network, to which those subjective loudness values, or ratios, or differences with reference subjective loudness values, are input.

The method may comprise a step of selecting from a list a music genre for said audio file. In that case, classifying may depend on the selected music genre. For example, the method may include selecting reference subjective loudness values associated with said music genre.

The classification might indicate a quality factor of the audio file.

The quality factor might be used as one factor for predicting the popularity of the audio file. It can be shown that, at a given time and for a given music genre, popular tracks are more likely to have a given distribution of loudness among frequency ranges.

The quality factor may be indicated to a user. The user can use this indication for selecting the audio file, or for verifying if a change made to an audio file during its creation is appropriate.

The method may include a step of automatically ranking or selecting one or a plurality of audio file, using that quality factor.

The classification may involve determining a music genre associated with said audio file.

The number of predefined frequency ranges is preferably lower than 10, preferably 4.

In one embodiment, the predefined frequency ranges correspond to low frequency (60-250 Hz), mid-low frequency (or low midrange, from 250 to 500 Hz), mid frequency (500 to 2 KHz), and high frequency (2 KHz to 20 KHz) ranges.

Other frequency ranges may be used, such as sub-bass (20-60 Hz); upper midrange (2 KHz to 4 KHz); presence (4 KHz to 6 KHz), and brilliance 6 Hz to 20 KHz).

The step of classifying may be performed using a machine learning based classifying engine for classifying audio files.

The machine learning based classifying engine might be trained with a corpus of already classified music tracks. In one example, the training elements input to a feedback loop of the machine learning classifying engine include the success of music tracks, for example the number of streaming, sales or downloads from a platform, the number of likes on a social network, etc.

The machine learning based classifying engine may be trained with audio files downloaded using an API of a streaming music platform and analysed according to the claimed method, wherein the success of each audio file is used as feedback for training the classifying engine.

The classification might be additionally based on other low-level features of the audio file, such as:
Panning balance, i.e., whether the signal in the audio file is correctly distributed along the stereophonic left/right axis, whether the stereophonic width is appropriate, and/or whether instruments are correctly distributed along the stereophonic axis.
Peak level, i.e., max LUFS that should be in a given range.
Music scale analysis. For example, if different instruments play on a different musical scale, or if the musical scale changes during the song.
Tonality, i.e., whether the music is tonal or atonal
Detection of discontinuities in the song, sometimes perceived as clicks, if successive audio segments are chained together without signal continuity.
Monaurality-compatibility. Although most quality tracks are mixed in stereo, it is important to consider that music is still often listened to with monaural installations. This is especially the case in many clubs. It is therefore important to ensure that a track produced in stereo can also be reproduced on a monaural system with sufficient quality.

At least some of those other low-level features of the audio file may be input to a classifying engine, such as a neural network, along with features derived from the LUFs in different frequency ranges, so as to classify the audio file.

The classification might be based on other features of the audio file, such as:
Compression rate and type. Audio files which are not compressed, or which are using a better compression rate or type, will be associated with a better quality factor.
Length of the track. Tracks that are too short or too long will be associated with a bad quality factor.
Copyright notice (present or not?)
Etc

The method of the invention might include comparing the audio file with a corpus of previous audio files, detecting similar audio files as possible copyright violation or lack of originality, and using such a detection of similarity as an entry feature of the classifying engine.

The automatic classification of audio files using the low-level features and/or other features of the audio file and the method of the invention can be used for various technical applications.

In one embodiment, this classification can be used to improve the ranking or selection of audio files, such as songs, tracks or samples, on a platform for distribution of such files.

This classification can also be used during the creation of musical pieces, especially electronic music songs, for selecting high quality samples, and for validating more quickly and reliably the different arrangements and modifications successively made to the piece of its composition.

This classification can also be used as a success predictor, to predict the success of a new musical piece or a new sample.

The classifying engine may also be used for detecting trends in music and predicting which proportion of subjective loudness in different frequency ranges may be popular at a given time in the future, based on the evolution of such proportions in the past.

The classification may be used every time when a manual ranking or selection of audio files is not possible or too cumbersome, for example when a number of audio files to select from or to rank is very high (for example more than 1000, or even more than 10,000), and/or when a selection based on low level features of the audio signal that are difficult to detect manually is needed.

### SHORT DESCRIPTION OF THE DRAWINGS

Exemplar embodiments of the invention are disclosed in the description and illustrated by the drawings in which:

FIG. 1 illustrates schematically a system for performing the method of the present invention.

FIG. 2 illustrates an example of audio signal in analog and digital form

FIG. 3 illustrates example LUFS in different frequency ranges of the loudest portion of the audio file.

FIG. 4 illustrates curves of LUFS in different frequency ranges of the loudest portion of the currently analysed audio file and reference LUFS in each such frequency ranges.

FIG. 5 is an example of flow chart of the method of the invention.

### EXAMPLES OF EMBODIMENTS OF THE PRESENT INVENTION

FIG. 1 schematically illustrates an example of system adapted to carry out the method according to the invention. The system includes a feature extraction module 10 adapted to preprocess a digital audio file tₖ and to extract features fi from this signal, including low-level features and possibly high-level features.

The signal tₖ may correspond, for example, to a track of music, a portion of a track, and/or an audio segment to be used for creating such a track, for example a sample used in electronic music composition. The signal tₖ may be stored in a digital memory (not shown). It may consist of a compressed, or uncompressed, digital signal. It may include metadata, e.g., a title, copyright information, etc.

The feature extraction module 10 may include hardware components, e.g., a processor, an FPGA, a DSP, a server, etc., as well as software components, e.g., one or more computer programs arranged to analyze the digital audio file tₖ, and to analyze this signal to extract features fi described below.

The feature extraction module 10 may extract other features fi from the digital audio signal, such as.
Panning balance, i.e., whether the signal in the audio file is correctly distributed along the stereophonic left/right axis, whether the stereophonic width is appropriate, and/or whether instruments are correctly distributed along the stereophonic axis.
Loudness peak level, such as subjective loudness peak level.
Progression of subjective loudness values in different frequency ranges during the track, and/or during the loudest portion of the track.
Rhythm (for example beats per minutes).
Music scale analysis. For example, if different instruments play on a different musical scale, or if the musical scale changes during the song.
Tonality, i.e., whether the music is tonal or atonal
Detection of discontinuities in the song, sometimes perceived as clicks, if successive audio segments are chained together without signal continuity.
Monaurality-compatibility. Although most quality tracks are mixed in stereo, it is important to consider that music is still often listened to with monaural installations. This is especially the case in many clubs. It is therefore important to ensure that a track produced in stereo can also be reproduced on a monaural system with sufficient quality.
Number of audio channels (monaural, stereo, surround, etc)

The classifying engine 20 is a hardware and/or software module for classifying the digital audio file tₖ according to the features fᵢ extracted by the feature extraction module 10 and for determining one or more classes cⱼ to which the signal belongs. In addition to the features fᵢ extracted from the audio file, the classifying engine 20 can receive and use context data dᵢ entered by a user, and/or data associated with the audio file and determined from a database or from the Internet. The context data dᵢ used by the classifying engine 20 may for example include the name of the artist, the title of the album, other data related to the album or to the audio file, and/or a list of related audio tracks entered by the artist or producer.

The classifying engine 20 may include hardware components, e.g., a processor, an FPGA, a DSP, a graphic card, a server, etc., as well as software components, e.g., one or more computer programs arranged to classify the features of the audio signal.

One of the classes cⱼ may correspond to a quality factor to which the audio file belongs. The quality factor may be indicated by, for example, a mark, a number of stars, etc., to indicate the quality of the audio file.

The quality factor may depend on the music genre. For example, the class cj may corresponding to a quality factor depending on whether the subjective loudness values of a portion of an audio file in predefined frequency ranges match the average subjective loudness values of successful audio files of the same music genre.

One of the cⱼ classes may also correspond to a music genre automatically determined from the classifier, for example a genre determined among a predetermined list of music genres, such as ambient, dub, experimental, techno, house etc.

The automatic determination of music genre with the classifying engine 20 may be used for determining the music genre if not indicated by the user, or for verifying a previously indicated music genre.

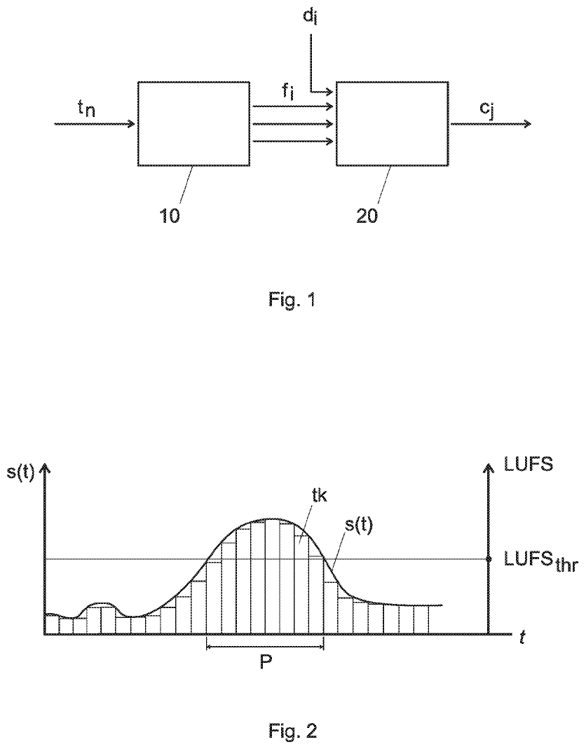

FIG. 2 illustrates an example of an analog audio file s (t) and, schematically, an uncompressed digital audio file tₖ, consisting of a sequence of digital samples representing the signal s (t) in digital form. The feature extraction module 10 is arranged for calculating the subjective loudness at each time. In one embodiment, the feature extraction module determines a short-term loudness unit relative to full scale (LUFS) of the digital audio file tₖ. The short-term loudness unit relative to full scale is a 10 standard subjective loudness measurement unit audio file, measured over a short period of time, such as, typically three seconds.

The loudest portion of the digital audio file, p, is represented on FIG. 2. The expression “loudest portion” is subjective and designates a significant portion of the audio file, perceived as being “the loudest”. In electronic dance music, it corresponds to the drop, or to the period after the drop, where a sudden change of rhythm or bass line occurs following the build-up section of the track. In some pop or rock songs, the loudest portion of the audio file corresponds to the first chorus.

The drop is usually the most important one of the audio file, the one that mostly determines its success, and on which the classification should be based. By focusing the classification on features of this portion p only, the classifying method of the invention is more efficient and more adapted to the fast classification of large quantities of audio files.

In the context of electronic music production, the term “drop” refers to a significant and often highly energetic section of a song. The drop is a crucial element in many electronic music genres, including dubstep, house, techno, and more. It's a moment in the song where the energy, subjective loudness and/or intensity reach a peak, and it often comprises some key features:
1. Build-Up: Before the drop, there is usually a build-up section where tension and anticipation are gradually increased. This buildup can include elements like rising synths, vocal samples, or percussion patterns.
2. Release: The drop itself is a release of this built-up tension. It's where the main musical elements come together in a powerful and impactful way. Having several musical instruments, and/or a voice, come together create a high subjective loudness.
3. Intensity: The drop is typically the most intense part of the song, often featuring heavy basslines, powerful drum patterns, and/or often intricate melodies or sound design elements. It's where the “core” of the track is showcased.
4. Danceability: Drops are designed to be danceable and are often the moments in a track where the crowd on a dance floor gets the most engaged, moving to the beat.
5. Variations: Electronic music producers often create variations in the drop to keep the audience's interest. This can involve changing the rhythm, adding or removing elements, or introducing unexpected surprises.
6. Climax: The drop is considered the climax of the song and is typically the part that listeners remember most. It's the “hook” of the track that can make it stand out and be memorable.
7. Duration: The length of a drop can vary depending on the track and the artist's style, but it is usually relatively short compared to the overall song length.

The drop of the audio file is thus an important portion p of that file. The features of the drop are important in the classification of the audio file.

In this text, the terms “drop” and “loudest portion” are sometimes used interchangeably, although the loudest portion may be only a portion of the drop.

The “loudest portion” p thus corresponds to one representative portion of the audio file, i.e. a period that is loud, that can comprises peaks (loud samples), and that can comprise a lot of energy (LUFs) in the bass portions of the spectrum, and/or over the whole spectrum.

This “loudest portion” typically corresponds to a portion of the audio file, for example during the drop, where more instruments are playing simultaneously at high volume.

According to the invention, any of the above mentioned unique features of the drop may be used for detecting the drop, or loudest portion p of an audio file. We will now describe various possible methods.

The loudest portion p may be determined by the feature extraction module 10. In one example, the start of this portion corresponds to the first sudden increase of global loudness, and/or a sudden change of rhythm or loudness in the bass frequency range. The end of the section p may for example correspond to a sudden decrease of loudness, to a change of loudness in the bass frequency range. Alternatively, the feature extraction module 10 may terminate the period p after a given duration, such as for example a duration d between 9 and 60 seconds, as a longer analysis would be less efficient and unlikely to change the classification of the audio file.

In an alternative, the loudest portion p may also be determined by retrieving the longest and/or first continuous time interval during which the short term LUFS of the digital audio file exceeds a threshold LUFSₜₕᵣ. This threshold may be a predetermined value, or computed as a percentage or percentile of the maximum short-term LUFS for the track. Other methods could be used for determining the loudest portion p of the audio file.

In another alternative, the method for determining the loudest portion p of the audio file comprises the steps of:
a) determining N peaks, for example the loudest samples (or groups of consecutive M Samples) in the audio file, N being an integer between 2 and 10, for example 5;
b) extracting a window of duration d comprising each said sample or group of samples, for example a window centered around said sample of group of consecutive samples. The duration d may be comprised between 6 and 60 seconds, for example between 6 and 20 seconds, preferably between 6 and 12 seconds.
c) selecting among said windows the sample with the highest energy, for example the sample with the highest average or median LUF, or the window with more bass, etc, said window being the loudest portion.

In another alternative, the method for determining the loudest portion p of the audio file comprises the steps of computing the average or total LUF (subjective loudness value) in an window of duration d starting at times t₀, t₀+1*ΔT, t₀+2*ΔT, . . . t₀+i*ΔT etc of the audio file (sliding window); and selecting as loudest portion p the window with the highest average or total energy.

In another alternative, the method for determining the loudest portion p of the audio file uses a self-learning machine for automatically determining the loudest portion of the audio file. The self-learning machine may be trained for example with humans selecting and annotating what they consider to be the drop of the audio file, or the chorus, or another loud or representative portion.

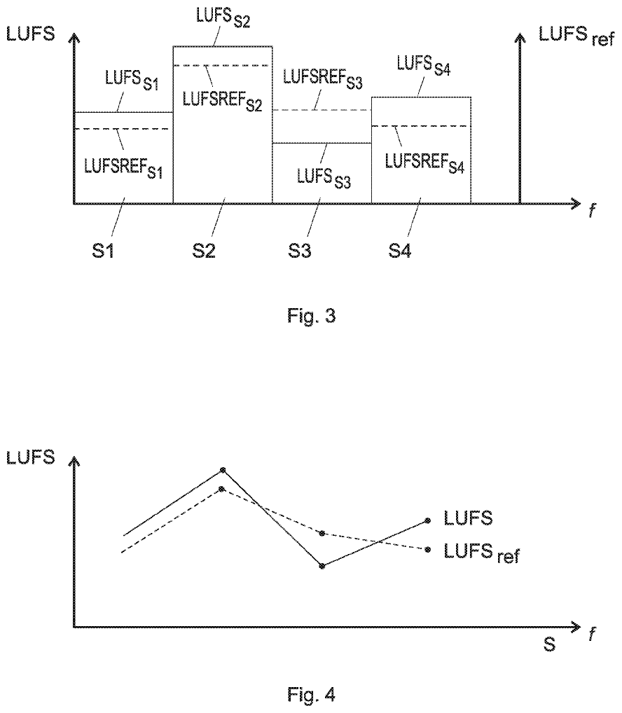

FIG. 3 is a plot that represents the subjective loudness, for example the LUFS_{Si}, of this loudest portion p in several frequency ranges Sᵢ. In the illustrated example, the subjective loudness in LUFS is measured for the portion p in 4 audio frequency ranges S₁ to S₄, corresponding for example to bass, mid-bass, mid, and high. A different number of frequency ranges can be used. The feature extraction module 10 calculates the LUFS for the entire duration of the loudest portion p, in each of these predefined frequency ranges.

FIG. 3 also shows reference loudness values, for example reference LUFS values LUFS_{ref}, for each of these predefined frequency ranges Sᵢ. These reference LUFS_{REFSi} values, and the corresponding ranges, may indicate the subjective loudness in each frequency range most often used in successful music tracks

In a various embodiment, the reference subjective loudness values may be indicated visually as a range for each frequency range, for example a range within which a given percentage, such as 80% or 90%, of the LUFS of audio files in a given corpus are included.

These reference LUFS_{REFSi} values, and the corresponding ranges, can be determined from a corpus of successful audio files, such as music tracks, for example downloaded with an API from a music platform

These reference subjective loudness values may depend on the music genre. A user can for example select of music genre and check with the loundness values in each frequency range correspond or are close to reference values or references value ranges for this music genre.

These reference subjective loudness values may also vary over time; for example, successful music tracks often included more loudness in the bass section ten years ago than they do now.

FIG. 4 illustrates curves of subjective loudness (LUFS) in different frequency ranges of the loudest portion of the analyzed audio file and reference subjective loudness values. In the example, the analyzed signal is louder (more LUFS) in the bass, mid bass and high frequency ranges than the reference values, but quieter in the mid frequency range.

The feature extraction module 10 may also extract features useful for a determination of the quality of the composition of the audio track Those features may include for example the duration of different sections (intro, build-up section, drop etc), the loudness of each section, the repartition of loudness in different frequency ranges for each such section, and/or other low level features relative to ach such section. Those features relative to the quality of the composition are preferably extracted from the whole audio track, and not only from the loudest portion p.

The values of subjective loudness in each frequency range can be input to the classifying engine 20 as features fᵢ. Alternatively, ratios between values of subjective loudness in different frequency ranges, and/or the differences, or sum of differences, between subjective loudness values in each frequency range and reference subjective loudness values for those frequency ranges can be computed and used as features fᵢ.

Other features fᵢ of the audio track as extracted by the feature extraction module 10, and/or context data dᵢ, can be input to the classifying engine 10.

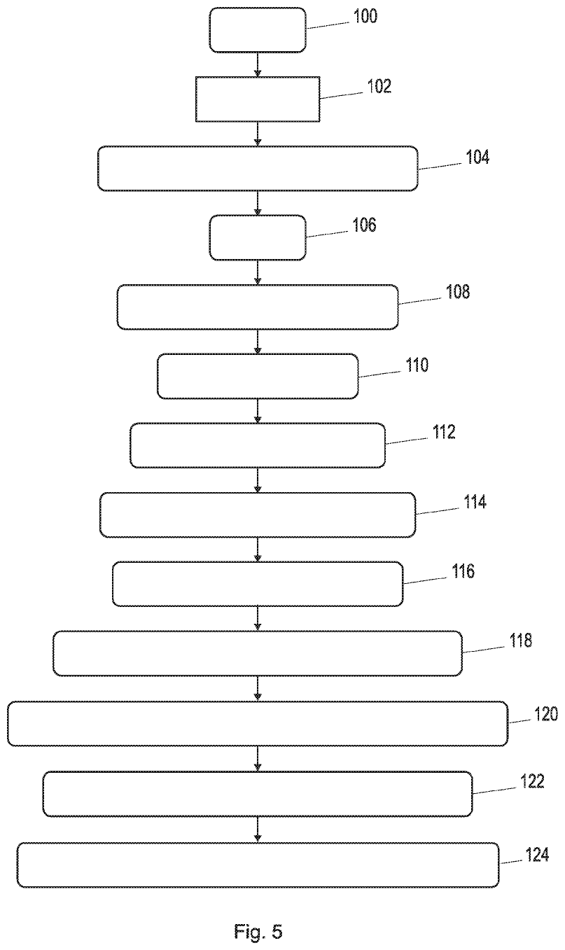

FIG. 5 illustrates an example of flowchart according to one embodiment of the method of the invention. The process starts at step 100.

At step 102, a user who wants to classify an audio file, for example to determine a quality factor, to predict its success, or to determine its music genre, connects to the software on a personal computing system (such a personal computer, a smartphone, a tablet etc), or to a remote platform on the web for example, and authenticates himself.

At optional step 104, the user selects a music genre (such as techno, experimental, ambient, etc. . . . ) as parameter dⱼ from a predefined list of genres. Alternatively, this step might be omitted. The genre might be retrieved automatically from the audio file, as will be described.

At step 106, the user uploads a digital audio file, for example a piece of music, a song, a portion of a song, a sample, etc. Alternatively, the user might select this audio file from a music platform. The digital audio file might be a file in any suitable digital audio file format, such as MP3, AAC, Wav, Flac, etc. The file might be uncompressed, compressed with a lossless compression scheme, or compressed with a lossy scheme. Metadata might be included or attached to the digital audio file.

At step 108, the digital audio file is saved in a digital memory, for example in a memory of the user equipment or in a remote server.

At step 110, the analysis of the audio file by the feature extraction module 10 starts. At step 112, the loudest portion p of the audio file is extracted, as described previously. The loudest portion might be for example the portion after the drop, or the first continuous portion of the audio file where the loudness exceeds a percentage or percentile of the peak loudness, or of the average loudness over the whole audio file.

At step 114, the feature extraction module 10 determines the average subjective loudness value of this loudest portion. The subjective loudness value may also be used by the classifying engine 20 for classifying the audio track; in electronic dance music, audio tracks which are not loud enough tend to be less successful.

At step 116, the feature extraction module 10 computes a frequency transform of the loudest portion p, using for example a FFT transform.

At step 118, the feature extraction module 10 divides the frequency transform of the portion p in N frequency ranges, such a four frequency ranges corresponding to bass, mid bass, mid and high frequency ranges.

At step 120, the feature extraction module computes the subjective loudness (for example the LUFTS) in each of those N frequency ranges and determine a curve of subjective loudness value across those frequency ranges, as illustrated in FIG. 4. Alternatively, or in addition, the module 10 can also determine proportions between the subjective loudness values in those different ranges.

At step 122, the feature extraction module 10 retrieves a reference curve of subjective loudness value. If a music genre was entered, the module might retrieve a reference curve of subjective loudness value associated with that music genre.

At step 124, the values of subjective loudness in each predefined frequency range, or the proportions between those values, or the differences between those values and reference loudness values for the selected music genre, or any other parameter derived from those values, is input as features fᵢ to the classifying engine 20, possibly with other features and with other user-input data dⱼ. The classifying engine then classify the audio file depending on those features fᵢ and data dⱼ.

The output of the classifying engine 20 may be for example a quality factor indicating the quality of the audio file, depending at least on the subjective loudness values in predefined frequency ranges.

The output of the classifying engine 20 may include for example an indication on the quality of the composition, depending on the above-mentioned features relative to the composition. The quality of composition may depend on a respect of composition rules depending on each music genre. For example, the progression of loudness values in various frequency ranges often depends on the progression of bass line, chords etc during the track, and may be used by the classifying engine for classifying the quality of composition, depending on the composition of previously successful audio tracks.

The output of the classifying engine 20 may include for example an indication on the danceability, depending on the subjective loudness in different frequency ranges of the loudest portion, and/or on other low-level features such as rhythm, progression of subjective loudness values, etc.

Those quality factors may be indicated to the user, and/or used for automatically ranking or selecting the audio file among a list of other audio files.

The invention is also related to a computer program product storing a computer program arranged for performing the above-mentioned steps when executed.

### Additional Features and Terminology

Many other variations than those described herein will be apparent from this disclosure. For example, depending on the embodiment, certain acts, events, or functions of any of the algorithms described herein can be performed in a different sequence, can be added, merged, or left out altogether (for example, not all described acts or events are necessary for the practice of the algorithms). Moreover, in certain embodiments, acts or events can be performed concurrently, for instance, through multi-threaded processing, interrupt processing, or multiple processors or processor cores or on other parallel architectures, rather than sequentially.

In addition, different tasks or processes can be performed by different machines or computing systems that can function together.

Unless otherwise specified, the various illustrative logical blocks, modules, engines and algorithm steps described herein can be implemented as electronic hardware, computer software, or combinations of both. To clearly illustrate this interchangeability of hardware and software, various illustrative components, blocks, modules, engines, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

Unless otherwise specified, the various illustrative logical blocks engines and modules described in connection with the embodiments disclosed herein can be implemented or performed by a machine, a microprocessor, a computer, a smartphone, a tablet, a server, a plurality of computers and/or servers connected through a network, for example in a LAN or in a cloud, a state machine, a digital signal processor (DSP), an application specific integrated circuit (ASIC), a FPGA, or other programmable logic device, discrete gate or transistor logic, discrete hardware components, or any combination thereof designed to perform the functions described herein. A hardware processor can include electrical circuitry or digital logic circuitry configured to process computer-executable instructions. In another embodiment, a processor includes an FPGA or other programmable device that performs logic operations without processing computer-executable instructions. A processor can also be implemented as a combination of computing devices, e.g., a combination of a DSP and a microprocessor, a plurality of microprocessors, one or more microprocessors in conjunction with a DSP core, or any other such configuration. A computing environment can include any type of computer system, including, but not limited to, a computer system based on a microprocessor, a mainframe computer, a digital signal processor, a portable computing device, a device controller, or a computational engine within an appliance, to name a few.

Unless otherwise specified, the steps of a method, process, or algorithm described in connection with the embodiments disclosed herein can be embodied directly in hardware, in a software module stored in one or more memory devices and executed by one or more processors, or in a combination of the two. A software module can reside in RAM memory, flash memory, ROM memory, EPROM memory, EEPROM memory, registers, hard disk, a removable disk, a CD-ROM, or any other form of non-transitory computer-readable storage medium, media, or physical computer storage known in the art. An example storage medium can be coupled to the processor such that the processor can read information from, and write information to, the storage medium. In the alternative, the storage medium can be integral to the processor. The storage medium can be volatile or nonvolatile. The processor and the storage medium can reside in an ASIC.

Unless otherwise specified, the expression “song” is used in this application to designate any piece of audio music, even if it does contain any lyrics. For example, a piece of electronic music will only be called a “song”. A “track” is used in this application to designate any recording of a song, i.e., a single stream of recorded sound (even if the recording includes several instruments initially recorded on different audio tracks or with a multitrack mixing pult).

Unless specified otherwise, “classifying a file” means here “assigning at least one class to a file”. Classifying a file does not necessarily involves moving the file, nor changing the file. For example, classifying can happen by assigning a tag to that file, changing metadata of the file, changing data related to the file, changing the file, or otherwise saving information related to the fact that the file belongs to one or a plurality of classes.

The classification of an audio file may indicate its quality. For example, giving a mark, such as a mark from 1 to 10, to an audio file for indicating its quality is equivalent to classifying the audio file in quality class 4.

The classification of an audio file may indicate its suitability for a specific purpose. For example, specific requirements may be asked for audio music files or tracks to be played in a club; other requirements may be asked for music to be played individually with a headset. The classification of an audio file may indicate whether the audio file is suitable for this purpose, or to which extent it is suitable.

The classification of an audio file may indicate the music genre to which it most likely belongs, determined from low level features of the audio signal stored in the file.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements or states. Thus, such conditional language is not generally intended to imply that features, elements or states are in any way required for one or more embodiments or that one or more embodiments necessarily include logic for deciding, with or without author input or prompting, whether these features, elements or states are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all the elements in the list. Further, the term “each,” as used herein, in addition to having its ordinary meaning, can mean any subset of a set of elements to which the term “each” is applied.

1-23. (canceled)

24. A computer assisted method for classifying a digital audio file based on features of a digital audio signal comprised in the file, comprising:
storing the digital audio file in a digital memory,
determining a portion of the digital audio file included in a drop of the digital audio file, and classifying said digital audio file based on features of said portion.

25. The method of claim 24, wherein said portion is the portion with the highest subjective loudness.

26. The method of claim 24, wherein the step of determining a portion of the digital audio file comprises determining the start of a portion when the first sudden increase in loudness and/or a sudden change of rhythm or loudness in the bass frequency range occurs.

27. The method of claim 24, wherein the step of determining a portion of the digital audio file comprises determining the longest and/or first continuous time interval during which short term LUFS of the digital audio file exceeds a threshold LUFSₜₕᵣ.

28. The method of claim 24, wherein the step of determining a portion of the digital audio file comprises the steps of:
a) determining N peak in the digital audio file, N being an integer between 2 and 10;
b) extracting a window of duration d comprising each said sample or group of samples,
c) selecting among said windows the window with the highest average or median LUF, or the window with more bass, said window being the loudest portion.

29. The method of claim 24, wherein the step of determining a portion of the digital audio file comprises the steps of computing the average or total LUF in a series of windows of duration d starting at times t₀, t₀+1*ΔT, t₀+2*ΔT, . . . t₀+i*ΔT etc of the digital audio file; and selecting as loudest portion the window with the highest average or total energy.

30. The method of claim 24, wherein the step of determining a portion of the digital audio file comprises using a self-learning machine for automatically determining the loudest portion of the digital audio file.

31. The method of claim 24, further comprising:
computing a digital frequency transform of said portion;
dividing said digital frequency transform into a plurality of predefined frequency ranges;
establishing the subjective loudness in each said frequency ranges;
wherein said features for classifying said digital audio file include the subjective loudness in each said frequency range.

32. The method of claim 31, further comprising:
computing proportions of subjective loudness values between a plurality of said frequency ranges;
comparing the subjective loudness values in each said frequency ranges with reference subjective loudness in corresponding frequency ranges;
said classifying being based on the comparison.

33. The method of claim 24, said classifying involving determining or verifying a music genre associated with said digital audio file.

34. The method of claim 24, said classifying involving determining a quality factor for said digital audio file.

35. The method of claim 31, wherein the number of predefined frequency ranges is between 4 and 7.

36. The method of claim 24, further comprising a step of determining a danceability factor of said digital audio file, based at least on the subjective loudness values in different frequency ranges of different sections, on the duration of those sections, on the subjective loudness progression, and on the rhythm.

37. A computer program product storing a computer program arranged for performing the steps of claim 24 when executed by a processor.
